(19) United States
(12) Patent Application Publication
(10) Pub. No.: US 2024/0072556 A1
(43) Pub. Date: Feb. 29, 2024

(54) SYSTEMS AND METHODS FOR GENERATING POWER WAVES IN A WIRELESS POWER TRANSMISSION SYSTEM

(71) Applicant: Energous Corporation, San Jose, CA (US)

(72) Inventor: Michael A. Leabman, San Ramon, CA (US)

(21) Appl. No.: 18/241,820

(22) Filed: Sep. 1, 2023

Related U.S. Application Data
(63) Continuation of application No. 17/020,568, filed on Sep. 14, 2020, now Pat. No. 11,777,328.
Application No. 17/020,568 is a continuation of application No. 15/059,898, filed on Mar. 3, 2016, now Pat. No. 10,778,041.
Application No. 15/059,898 is a continuation-in-part of application No. 14/856,337, filed on Sep. 16, 2015, now Pat. No. 10,312,715.
(60) Provisional application No. 62/272,454, filed on Dec. 29, 2015.

(51) Int. Cl. H02J 7/00; G06V 40/10; H02J 50/20; H02J 50/60; H02J 50/80; H02J 50/90; H04B 5/00; H04N 7/18; H04W 52/28

(52) U.S. Cl. CPC H02J 7/0047; G06V 40/10; H02J 7/0029; H02J 50/20; H02J 50/60; H02J 50/80; H02J 50/90; H04B 5/0037; H04N 7/18; H04W 52/283; H02J 7/00034

(57) ABSTRACT

Embodiments disclosed herein may generate and transmit power waves that, as result of their physical waveform characteristics (e.g., frequency, amplitude, phase, gain, direction), converge at a predetermined location in a transmission field to generate a pocket of energy. Receivers associated with an electronic device being powered by the wireless charging system, may extract energy from these pockets of energy and then convert that energy into usable electric power for the electronic device associated with a receiver. The pockets of energy may manifest as a three-dimensional field (e.g., transmission field) where energy may be harvested by a receiver positioned within or nearby the pocket of energy.

### CROSS-REFERENCE TO RELATED APPLICATIONS

This application is a continuation of U.S. Non-Provisional patent application Ser. No. 17/020,568, filed on Sep. 14, 2020, entitled “Systems And Methods For Determining When To Wirelessly Transmit Power To A Location Within A Transmission Field Based On Predicted Specific Absorption Rate Values At The Location,” which is a continuation of U.S. Non-Provisional patent application Ser. No. 15/059,898, filed on Mar. 3, 2016 (now U.S. Pat. No. 10,778,041), entitled “Systems And Methods For Generating Power Waves In A Wireless Power Transmission System,” which claims the benefit of U.S. Provisional Patent Application Ser. No. 62/272,454, entitled “Systems And Methods for Generating Power Waves in a Wireless Power Transmission System,” filed Dec. 29, 2015, which are hereby incorporated by reference in their entirety.

U.S. Non-Provisional patent application Ser. No. 15/059,898 is a continuation-in-part of U.S. patent application Ser. No. 14/856,337, entitled “Receiver Devices Configured to Operate with a Wireless Charging System,” filed Sep. 16, 2015 (now U.S. Pat. No. 10,312,715), which is incorporated by reference herein in its entirety.

### TECHNICAL FIELD

This application generally relates to wireless charging systems and the hardware and software components used in such systems.

### BACKGROUND

Numerous attempts have been made to wirelessly transmit energy to electronic devices, where a receiver device can consume the transmission and convert it to electrical energy. However, most conventional techniques are unable to transmit energy at any meaningful distance. For example, magnetic resonance provides electric power to devices without requiring an electronic device to be wired to a power resonator. However, the electronic device is required to be proximately located to a coil of the power resonator (i.e., within a magnetic field). Other conventional solutions may not contemplate user mobility for users who are charging their mobile devices or such solutions do not allow devices to be outside of a narrow window of operability.

Wirelessly powering a remote electronic device requires a means for identifying the location of electronic devices within a transmission field of a power-transmitting device. Conventional systems typically attempt to proximately locate an electronic device, so there are no capabilities for identifying and mapping the spectrum of available devices to charge, for example, in a large coffee shop, household, office building, or other three-dimensional space in which electrical devices could potentially move around. Moreover, what is needed is a system for managing power wave production, both for directionality purposes and power output modulation. Because many conventional systems do not contemplate a wide range of movement of the electronic devices they service, what is also needed is a means for dynamically and accurately tracking electronic devices that may be serviced by the power-transmitting devices.

Wireless power transmission may need to satisfy certain regulatory requirements. The devices transmitting wireless energy may be required to adhere to electromagnetic field (EMF) exposure protection standards for humans or other living beings. Maximum exposure limits are defined by US and European standards in terms of power density limits and electric field limits (as well as magnetic field limits). Some of these limits are established by the Federal Communications Commission (FCC) for Maximum Permissible Exposure (MPE), and some limits are established by European regulators for radiation exposure. Limits established by the FCC for MPE are codified at 47 CFR § 1.1310. For electromagnetic field (EMF) frequencies in the microwave range, power density can be used to express an intensity of exposure. Power density is defined as power per unit area. For example, power density can be commonly expressed in terms of watts per square meter (W/m²), milliwatts per square centimeter (mW/cm²), or microwatts per square centimeter (μW/cm²).

Accordingly, it is desirable to appropriately administer the systems and methods for wireless power transmission to satisfy these regulatory requirements. What is needed is a means for wireless power transmission that incorporates various safety techniques to ensure that humans or other living beings within a transmission field are not exposed to EMF energy near or above regulatory limits or other nominal limits.

### SUMMARY

Disclosed herein are systems and methods intended to address the shortcomings in the art and may provide additional or alternative advantages as well. Embodiments disclosed herein may generate and transmit power waves that, as result of their physical waveform characteristics (e.g., frequency, amplitude, phase, gain, direction), converge at a predetermined location in a transmission field to generate a pocket of energy. Receivers associated with an electronic device being powered by the wireless charging system, may extract energy from these pockets of energy and then convert that energy into usable electric power for the electronic device associated with a receiver. The pockets of energy may manifest as a three-dimensional field (e.g., transmission field), where energy may be harvested by receivers positioned within or nearby a pocket of energy. In some embodiments, transmitters may perform adaptive pocket forming by adjusting transmission of the power waves in order to regulate power levels based on inputted sensor data from sensors or to avoid certain objects. A technique for identifying regions in the transmission field may be employed to determine where pockets of energy should be formed and where power waves should be transmitted. In one example, this technique may result in determination of a specific absorption rate (SAR) value at each spatial location within the transmission field with respect to one or more power waves radiated from one or more antennas in the transmission field. Determination of the specific SAR may be done by sensors coupled to, or integrated into, a transmitter. These sensors may. capture information useful for making SAR measurements within a transmission field, and the transmitter may use this information in conjunction with pre-stored calculations and estimates that determine the SAR values in the transmission field based on known propagation characteristics of the power waves produced by the transmitter. The SAR is the rate at which electromagnetic energy from radio frequency (RF) waves are absorbed by a human body or another living being. In another example, heat-map data, which is a form of mapping data that may be stored into a mapping memory for later reference or computations may be used in determining where pockets of energy should be formed. In yet another example, sensors may generate sensor data that may identify areas that the power waves should avoid. This sensor data may be an additional or alternative form of mapping data, which may also be stored into a mapping memory for later reference or computation.

In an embodiment, a method of wireless power transmission comprises calculating, by a transmitter, a specific absorption rate (SAR) value at each spatial location within a transmission field of the transmitter with respect to one or more power waves radiated from one or more antennas of the transmitter; determining, by the transmitter, a selected portion within the transmission field where the calculated SAR value fails a pre-defined SAR value threshold; and transmitting, by the transmitter, the one or more power waves to converge destructively at the selected portion within the transmission field.

In another embodiment, a method of wireless power transmission includes receiving, by a transmitter, a specific absorption rate (SAR) value at each spatial location within a transmission field of the transmitter with respect to one or more power waves radiated from one or more antennas. The method further includes determining, by the transmitter, a selected portion within the transmission field where the received SAR value is greater than a pre-defined SAR value. The method further includes transmitting, by the transmitter, the one or more power waves to converge destructively at the selected portion within the transmission field. The method further includes transmitting, by the transmitter, the one or more power waves to converge destructively to form a null space at remaining portions within the transmission field.

In another embodiment, a system for wireless power transmission may include one or more transmitters. Each of the one or more transmitters may include a microprocessor configured to calculate a specific absorption rate (SAR) value at each spatial location within a transmission field of the transmitter with respect to one or more power waves radiated from one or more antennas, and determine a selected portion within the transmission field where the calculated SAR value is greater than a pre-defined SAR value. Each of the one or more transmitters may further include one or more antenna arrays where each of the one or more antenna arrays includes one or more antennas configured to transmit power waves to converge destructively to form null space at the selected portion within the transmission field.

### BRIEF DESCRIPTION OF THE DRAWINGS

The accompanying drawings constitute a part of this specification and illustrate embodiments of the invention. The present disclosure can be better understood by referring to the following figures. The components in the figures are not necessarily to scale, emphasis instead being placed upon illustrating the principles of the disclosure.

FIG. 1A illustrates a wireless power transmission system, according to an exemplary embodiment.

FIG. 1B shows components of a system according to an exemplary embodiment.

FIG. 1C shows components of the system, according to the exemplary embodiment shown in FIG. 1B.

FIG. 2 illustrates a method to form a pocket of energy in a wireless power transmission system, according to an exemplary embodiment.

FIG. 3 illustrates a method for forming a null space in a wireless power transmission system, according to an exemplary embodiment.

### DETAILED DESCRIPTION

Reference will now be made to the exemplary embodiments illustrated in the drawings, and specific language will be used here to describe the same. It should be understood that no limitation of the scope of the invention is intended through the descriptions of such exemplary embodiments. Alterations and further modifications of the exemplary embodiments and additional applications implementing the principles of the inventive features, which would occur to a person skilled in the relevant art and having possession of this disclosure, are to be considered within the scope of this disclosure.

A pocket of energy used to provide power wirelessly may be formed at locations of constructive interference patterns of power waves transmitted by a transmitter. The pockets of energy may manifest as a three-dimensional field where energy may be harvested by receivers located within or proximate to the pocket of energy. In operation, the pocket of energy produced by the transmitters during pocket-forming processes may be harvested by a receiver, converted to an electrical charge, and then provided to an electronic device (e.g., laptop computer, smartphone, rechargeable battery) associated with the receiver to operate the device or to charge the device battery. In some embodiments, multiple transmitters and/or multiple receivers may power various electronic devices. The receiver may be separable from the electronic device or integrated with the electronic device.

Constructive interference may be a type of waveform interference that may be generated at the convergence of the power waves at a particular location within a transmission field associated with one or more transmitters. Constructive interference may occur when power waves converge and their respective waveform characteristics coalesce, thereby augmenting the amount of energy concentrated at the particular location where the power waves converge. The constructive interference may be the result of power waves having particular waveform characteristics such that constructive interference results in a field of energy or “pocket of energy” at the particular location in the transmission field where the power waves converge. In the case of periodic signals, such as chirp waves or sinusoidal waves, a constructive interference pattern is created when the positive and negative peaks of the power waves arriving at a specific location are synchronized. The correlated positive and negative peaks across the waveforms add cumulatively to create a cumulative waveform having a larger amplitude than each of the individual power waves.

Destructive interference may be another type of waveform interference that may be generated at the convergence of the power waves at a particular location within a transmission field associated with one or more transmitters. Destructive interference may occur when power waves converge at a particular location and their respective waveform characteristics are opposite each other (i.e., waveforms cancel each other out), thereby diminishing the amount of energy concentrated at the particular location. Where constructive interference may result in generating pockets of energy when enough energy is present, destructive interference may result in generating a negligible amount of energy or “null” at the particular location within the transmission field where the power waves converge to form destructive interference. In the case of periodic waves, such as chirp waves or sinusoidal waves, a destructive interference pattern results when the positive and negative peaks of the power waves arriving at a specific location subtract from each other, rather than adding cumulatively, and therefore a low (ideally zero) amplitude waveform signal results.

A transmitter may be an electronic device that comprises, or is otherwise associated with, various components and circuits responsible for, e.g., generating and transmitting power waves, forming pockets of energy at locations in a transmission field, monitoring the conditions of the transmission field, and generating null spaces where needed. A transmitter may generate and transmit power waves for pocket-forming and/or null steering based on a specific absorption rate (SAR) value determined by the transmitter at one or more spatial locations within a transmission field of the transmitter. The specific absorption rate (SAR) value may be determined by a transmitter processor, and indicate an electric power absorbed by a living tissue, such as a human body, exposed to a radio frequency (RF) wave. The transmitter may generate and transmit, or otherwise adjust, the power waves so that the SAR value for the RF energy at a particular location in the transmission field does not exceed a predetermined SAR threshold value.

A receiver may be an electronic device that comprises at least one antenna, at least one rectifying circuit, and at least one power converter, which may utilize a pocket of energy for powering or charging the electronic device. “Pocket-forming” may refer to generating one or more RF waves that converge in a transmission field, forming controlled pockets of energy and null spaces. A “pocket of energy” may refer to an area or region of space where energy or power may accumulate based on a convergence of waves causing constructive interference at that area or region. The “null-space” may refer to areas or regions of space where pockets of energy do not form, which may be caused by destructive interference of waves at that area or region.

A transmitter may determine the present SAR value of RF energy at one or more particular locations of the transmission field using one or more sampling or measurement techniques. In some implementations, the transmitter may be preloaded with values, tables, and/or algorithms that indicate for the transmitter which waveform characteristics are likely to exceed to a pre-stored SAR threshold value. For example, a lookup table may indicate that the SAR value for a volume of space (V) located some distance (D) from the transmitter receiving a number of power waves (P) having a particular frequency (F). One skilled in the art will appreciate that there could be any number of potential calculations, which may use any number of variables, to determine the SAR value of RF energy at a particular locations.

Moreover, a transmitter may apply the SAR values identified for particular locations in various ways when generating, transmitting, or adjusting the power waves. In some embodiments, the SAR values may be measured and used by the transmitter to maintain a constant energy level throughout the transmission field, where the energy level is both safely below a SAR threshold value but still contains enough RF energy for the receivers to effectively convert into electrical power. In some implementations, the transmitter may proactively modulate the power waves based upon the RF expected to result from newly formed power waves based upon the predetermined SAR values. For example, after determining how to generate or adjust the power waves, but prior to actually transmitting the power waves, the transmitter may determine whether the power waves to be transmitted will result in RF energy accumulation at a particular location that either satisfies or fails the SAR threshold. Additionally or alternatively, in some implementations, the transmitter may actively monitor the transmission field to reactively adjust power waves transmitted to or through a particular location when the transmitter determines that the power waves passing through or accumulating at the particular location fail the SAR threshold. Where the transmitter is configured to proactively and reactively adjust power waves, with the goal of maintaining a continuous power level throughout the transmission field, the transmitter may be configured to proactively adjust the power waves to be transmitted to a particular location to be certain the power waves will satisfy the SAR threshold, but may also continuously poll the SAR values at locations throughout the transmission field to determine whether the SAR values for power waves accumulating at or passing through particular locations unexpectedly fail the SAR threshold. In some embodiments, the transmitter may be configured to generate a pockets of energy or nulls at particular locations, and thus the SAR value may be used to determine whether areas around a pocket of energy are satisfactorily below the SAR threshold, or to determine the efficacy of the destructive interference patterns generating a null space.

Although the exemplary embodiments described herein mention the use of RF-based wave transmission technologies, it should be appreciated that the wireless charging techniques that might be employed are not be limited to such RF-based technologies and techniques. Rather, it should be appreciated that here are additional or alternative wireless charging techniques, which may include any number of technologies and techniques for wirelessly transmitting energy to a receiver that is capable of converting the transmitted energy to electrical power. Non-limiting exemplary transmission techniques for energy that can be converted by a receiving device into electrical power may include: ultrasound, microwave, laser light, infrared, or other forms of electromagnetic energy.

In some embodiments, control systems of transmitters adhere to electromagnetic field (EMF) exposure protection standards for human subjects. Maximum exposure limits are defined by US and European standards in terms of power density limits and electric field limits (as well as magnetic field limits). These include, for example, limits established by the Federal Communications Commission (FCC) for MPE, and limits established by European regulators for radiation exposure. Limits established by the FCC for MPE are codified at 47 CFR § 1.1310. For electromagnetic field (EMF) frequencies in the microwave range, power density can be used to express an intensity of exposure. Power density is defined as power per unit area. For example, power density can be commonly expressed in terms of watts per square meter (W/m²), milliwatts per square centimeter (mW/cm2), or microwatts per square centimeter (μW/cm2).

In some embodiments, the present systems and methods for wireless power transmission incorporate various safety techniques to ensure that human occupants in or near a transmission field are not exposed to EMF energy near or above regulatory limits or other nominal limits. One safety method is to include a margin of error (e.g., about 10% to 20%) beyond the nominal limits, so that human subjects are not exposed to power levels at or near the EMF exposure limits. A second safety method can provide staged protection measures, such as reduction or termination of wireless power transmission if humans (and in some embodiments, other living beings or sensitive objects) move toward a pocket of energy with power density levels exceeding EMF exposure limits.

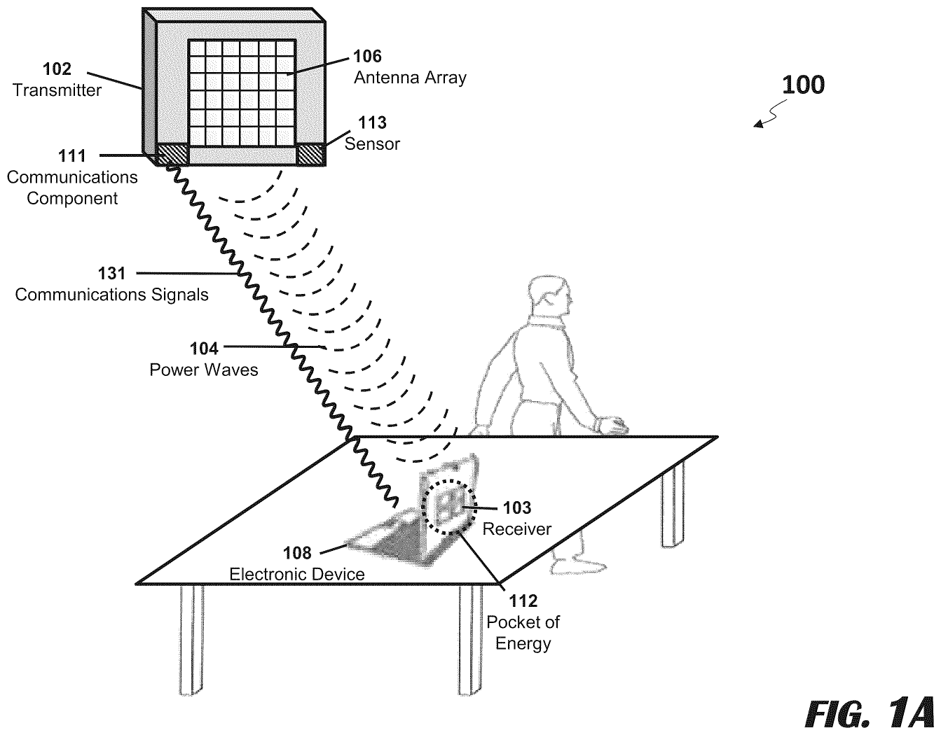

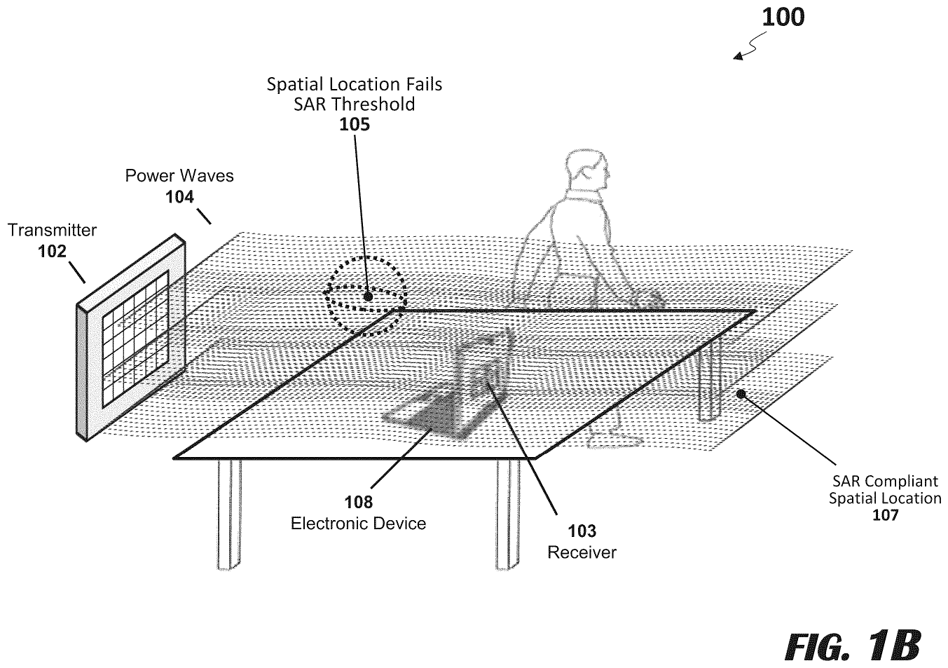

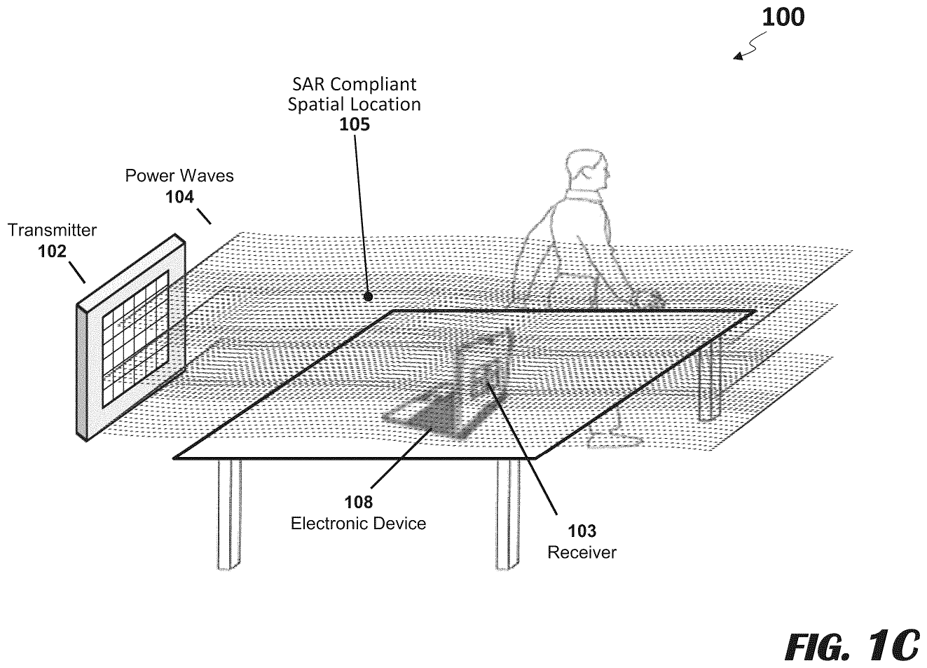

FIG. 1A illustrates a wireless power transmission system 100, according to an exemplary embodiment. The wireless power transmission system 100 comprises a transmitter 102 that transmits one or more power waves 104 from an antenna array 106. Non-limiting examples of power waves 104 may include microwaves, radio waves, and ultrasound waves. The power waves 104 are controlled through a microprocessor of the transmitter 102 to form a pocket of energy 112 at one or more locations in a transmission field, where the controller determines that a pocket of energy 112 is needed. The transmitter 102 is further configured to transmit the power waves 104 that may converge in three-dimensional space to create the one or more null spaces in the one or more locations where transmitted power waves cancel each other out substantially. In some implementations, the transmitter 102 may continuously measure the specific absorption rate (SAR) values of areas within the transmission field in order to maintain consistent energy levels throughout the transmission field. In such embodiments, the energy levels maintained may be high enough to provide power to receivers 103 charging electronic devices 108, 110, but remain below a given SAR threshold value. One skilled in the art would therefore appreciate that the generation of pockets of energy 112 or nulls, may not be necessary in every embodiment, as some embodiments may maintain a uniform or substantially uniform, safe and effective energy level throughout the transmission field. It would further be appreciated that the transmitter 102 may be configured to operate according to any combination of techniques for determining the appropriate means for delivering power waves 104 to receives 103 in a transmission field.

In some embodiments, the transmitter 102 may comprise or may otherwise be coupled to a memory or hard disk that stores predetermined SAR value determination criteria, such as algorithms, variables, tables, or other such information that a processor of the transmitter 102 may use to determine the SAR value at a given location, based on the characteristics of the power waves being transmitted to or through the given location, or about to be transmitted to or through the given location. The transmitter 102 may use known channel propagation models and empirical data on propagation losses collected prior to manufacture or prior to deployment, to calculate what the SAR may be at some distance from the transmitter 102. For example, prior to deployment or prior to manufacture, a probe may be used to scan a volume of space inside a model of living tissue, or other model intended to resemble the human body, such as a container filled with a liquid having nearly-equivalent characteristics of body-tissue, may be placed within a transmission field. The antenna array 106 of the transmitter 102 may transmit power waves 104 having various characteristics that cause the power waves 104 to be near and intersect with the model. The probe may measure the SAR values and RF energy levels in the proximity of the model and/or within the model. The probe may be used to register the RF energies and SAR values resulting from the various waveform characteristics, such as the amplitude, frequency, and vector characteristics, of the power waves 104 transmitted by the antenna array 106. The resulting SAR values and RF energies may be stored in a memory accessible to the transmitter 102, which may then use the pre-stored data to determine the SAR values at locations of a transmission field based on the characteristics of the power waves 104 being generated by the transmitter 102.

The receiver 103 and the transmitter 102 may comprise a communications component 111, which may be wireless communications chips configured to transmit various types of data through a communications signal 131 that is a distinct wireless communication channel independent from the power waves 104. In some cases, such as the receiver 103 of FIG. 1, the communications component may be embedded or otherwise integrated into an electronic device, such as a laptop 108 or other computer, coupled to the receiver 103 or transmitter 102. For example, the receiver 103 may be integrated into a laptop 108, and the communications component of the receiver 103 may include the native Bluetooth® chipset of laptop 108. In some cases, such as the transmitter 102 of FIG. 1, the communications component may be embedded or otherwise integrated into the transmitter 102 or receiver 103. In some embodiments, a communications component may be a distinct, stand alone structure from the transmitter 102, receiver 103, or any other electronic device. The transmitter 102 may transmit communications signals to the receiver 103 containing operational instructions for the receiver 103 to execute, or containing requests for power level data or other operational data from the receiver 103.

The microprocessor of the transmitter 102 is configured to determine how the power waves 104 should be generated and transmitted to provide energy effectively and to avoid living beings or other sensitive objects safely. Determining how the power waves 104 should be generated may be based on the SAR value sampled or determined at each spatial location within the transmission field of the transmitter 102 with respect to one or more power waves 104 radiated into the transmission field from one or more antennas of the transmitter 102. When determining how the power waves 104 should be generated and transmitted, the microcontroller may determine the physical characteristics of the power waves 104 (e.g., frequency, amplitude, phase), and/or which antennas of the transmitter 102 may be used to transmit the power waves 104. The transmitter 102 may determine the characteristics of the power waves 104, and/or identify a subset of the antennas to transmit the power waves 104, such that the power waves 104 converge at a particular location in a transmission field to create constructive and/or destructive interference patterns. Additionally or alternatively, the microcontroller may determine the characteristics and/or the antennas to transmit the power waves 104, such that the power waves 104 generate a uniform or substantially uniform energy level throughout the transmission field or at one or more particular localized areas of the transmission field.

As an example, based on a particular SAR value sampled at a particular location in the transmission field, the microprocessor of the transmitter 102 may select a type of waveform for the power waves 104 (e.g., chirp, sinusoidal, saw tooth, stepped), select the output frequency of the power waves 104, the shape of the one or more antenna arrays 106, and the spacing of the one or more antennas in at least one antenna array 106. Using one or more of these selections or determinations, the transmitter 100 may generate and transmit the power waves 104, and, as a result, the power waves 104 form the pocket of energy 112 at the targeted location to power one or more electronic devices 108, 110. The microprocessor of the transmitter 102 is further configured to, based on the SAR value at each spatial location within the transmission field of the transmitter 102, select the output frequency of the power waves 104, the shape of the one or more antenna arrays 106, and the spacing of the one or more antennas in at least one antenna array 106 to form the one or more null spaces at locations within the transmission field of the transmitter 102. The pockets of energy are formed where the power waves 104 accumulate to form a three-dimensional field of energy.

In the exemplary embodiment, the antennas of the antenna array 106 of the transmitter 102 are operable as the single array of one or more antennas. But in some cases, the microcontroller may segment the array into subsets operating to service multiple device or multiple regions in the transmission field. In an embodiment, the antenna array 106 may include antenna elements where the height of at least one antenna of the array 106 may range from about ⅛ inches to about 1 inch, and the width of the at least one antenna can be from about ⅛ inches to about 1 inch. A distance between two adjacent antennas in an antenna array 106 can be between about ⅓ to about 12 Lambda. For instance, in some cases, the distance between antennas can be greater than about 1 Lambda; in some cases, the distance between antennas can be between about 1 Lambda and about 10 Lambda; and in some cases, the distance can be between about 4 Lambda and about 10 Lambda. Lambda is the wavelength of the power waves 106, and may be used as a measurement for the spacing between antennas of the antenna array 106.

The transmitter 102 calculates the SAR value at each spatial location within the transmission field of the transmitter 102 with respect to one or more power waves 104 radiated from one or more antennas of the antenna array 106 in the transmission field. The microprocessor of the transmitter 102 then compares the calculated SAR value at each spatial location against a threshold SAR value. For example, based on FCC regulations, a pre-defined SAR value is about 1.6 watts per kilogram (W/Kg), so the transmitter 102 may adjust the various characteristics of the power waves 102 to reduce the amount of energy or power accumulating at a particular location in the transmission field, when the transmitter 102 determines that the power waves 102 accumulating at the particular location generate constructive interference patterns of 2.0 W/Kg, and thus no longer satisfy the threshold.

In some embodiments, the transmitter 102 may generate and transmit or otherwise adjust the power waves 104 when the calculated SAR value at a spatial location does not satisfy the pre-defined SAR value threshold. The microprocessor of the transmitter 104 may be configured to determine the characteristics for power waves 104 and/or determine from which antennas to transmit the power waves 104, so that the power waves 104 converge to form a destructive interference pattern at the particular location, and result in a null space having very little, negligible, or no energy accumulation at the portion in the transmission field. In some implementations, in order to generate null spaces, the transmitter 102 may generate a first set of power waves 104 that converge constructively to form pockets of energy 112, and then a second set of power waves 104 that converge destructively to form null spaces. In some embodiments, based upon the SAR values sampled at one or more locations of the transmission field, the microprocessor may generate and transmit, or otherwise adjust, the power waves 104 to converge constructively at certain locations within the transmission field, and simultaneously generate and transmit, or otherwise adjust, the power waves 104 to converge destructively to form the one or more null spaces at other locations within the transmission field.

In yet another embodiment, when the calculated SAR value is lesser than the pre-defined SAR value in a selected portion of the transmission field, the microprocessor is configured to select the type of power waves 104 to transmit such that the power waves 104 converge constructively at the selected portion within the transmission field, and simultaneously transmit any other type of power waves 104 that converge destructively to form the one or more null spaces in portions other than the selected portions in the transmission field. These power waves 104 may also be produced by using an external power source and a local oscillator chip using a piezoelectric material. The power waves 104 are constantly controlled by the microprocessor of the transmitter 102, which may also include a proprietary chip for adjusting phase and/or relative magnitudes of the power waves 104.

The microprocessor of the transmitter 102, may continuously or periodically receive and/or calculate SAR value according to one or more sampling triggers or parameters. In some instances, the microprocessor may determine the SAR value for predetermined locations according to a location sampling-interval (e.g., one-inch interval, one-foot intervals). In some instances, the microprocessor may continuously determine the SAR values of locations or may determine the SAR values at a given time sampling-interval. In some instances, the microprocessor may determine or receive the SAR value for locations whenever there is a change in frequency value of the one or more power waves 104. During sampling, the microprocessor of the transmitter 102 determines the SAR value of the new or adjusted power waves 104 at each predetermined location or at a given location sampling-interval and then compares the new SAR values obtained for each spatial location within the transmission field with the pre-defined SAR value threshold. Based on the results of the comparison, the microprocessor may identify, for example, a location within the transmission field area where the corresponding newly-calculated SAR value no longer satisfies the pre-defined SAR value. The microprocessor of the transmitter 102 may then manipulate the frequency, phase, amplitude, or other characteristics of the transmitted power waves 104, and/or the selection of new sets of antennas or antenna arrays for the transmission of new power waves 104 to control the transmission of the power waves 104.

The transmitter 102 may receive location data of one or more receivers within the transmission field of the transmitter 102. In another embodiment, the transmitter 102 determines location data of one or more receivers within the transmission field of the transmitter 102. The transmitter 102 calculates the SAR value at each of the one or more receiver locations and in a zone surrounding a predetermined distance from the one or more receivers within the transmission field of the transmitter 102. In another embodiment, the transmitter 102 receives the SAR value at each of the one or more receiver locations, as measured and reported by the receivers, and in a zone surrounding a predetermined distance from the one or more receivers within the transmission field of the transmitter 102. The microprocessor of the transmitter 102 then compares the calculated SAR value at each of the one or more receiver locations and in the zone surrounding the predetermined distance from the one or more receivers within the transmission field with a pre-defined SAR value. In an embodiment, the pre-defined SAR value can be 1.6 watts per kilogram (W/Kg). In another embodiment, the pre-defined SAR value can be any value established by the Federal Communications Commission (FCC).

When the calculated SAR value at each of the one or more receiver locations and in the zone surrounding the predetermined distance from the one or more receivers satisfies the pre-defined SAR value in a selected portion of the transmission field, the transmitter 102 may generate and transmit or otherwise adjust the power waves 104 to converge constructively at the selected portion within the transmission field. In another embodiment, when the calculated SAR value at each of the one or more receiver locations and in the zone surrounding the predetermined distance from the one or more receivers does not satisfy the pre-defined SAR value in a selected portion of the transmission field, the microprocessor is configured to generate and transmit, or otherwise adjust, the one or more power waves 104 to converge destructively to form one or more null spaces within selected portion in the transmission field.

In order to determine the location of the one or more receivers, the transmitter 102 may continuously transmit the power waves 104 and a communication signal into the transmission field of the transmitter 102. The power waves 104 may be any type of wave having any set of characteristics that may provide power to the one or more receivers located at a given location within the transmission field. Non-limiting examples of power waves may include ultrasonic waves, microwaves, infrared waves, and radio-frequency waves. The power waves 104 may be transmitted with a certain set of physical characteristics (e.g., frequency, phase, energy level, amplitude, distance, direction) that result in the power waves 104 providing elevated energy levels at the given location in the transmission field. In some embodiments, the transmitter 102 may transmit so-called exploratory power waves, which are power waves having a power level comparatively lower than the power level ordinarily used for the power waves providing power to the one or more receivers. The exploratory power waves may be used to identify the one or more receivers, and/or used to determine the appropriate characteristics for the power waves 104 that will ultimately provide power to the one or more receivers in the transmission field.

The communication signal may be any type of wave used by electrical devices to communicate data through associated protocols. Non-limiting examples may include Bluetooth®, NFC, Wi-Fi, ZigBee®, and the like. The communications signal may be used to communicate parameters used by the transmitter 102 to properly formulate the power waves 104. The communications signal may contain data describing the characteristics of the low-level power waves being transmitted. This data may indicate, for example, the direction and energy level of the power waves 104 transmitted along with the communication signal.

One or more antennas of the one or more receivers may receive the power waves 104 and the communication signal from the transmitter 102. The power waves 104 may have waveform characteristics that give the power waves 104 low-levels of power. The communication signal may contain data indicating the characteristics of the power waves 104. When the transmitter 102 formulates and/or transmits the power waves 104 in a certain direction or to a certain location within the transmission field, a communications component 111 of the transmitter 102 may generate and transmit data, within the communications signal 114, describing the power waves 104. For example, the communications signal 114 may indicate information about the power wave, such as the amplitude, frequency, energy level, the trajectory of the power waves, and/or the desired location to which the power waves were transmitted.

In some embodiments, a receiver 103 may then respond to the transmitter 102 with an indication of its location, for example, an explicit communication of location information or a communication indicating receipt of an exploratory low power wave transmission in a segment or sub-segment, and/or confirmation that the power level of said exploratory wave exceeds a particular threshold within the transmission field, using the data in the communications signal as input parameters. The one or more receivers may comprise a processor configured to generate a message for responding to the transmitter 102 with the indication of its location. The one or more receivers may be integrated into (e.g., within a smart phone) or coupled to (e.g., a smart phone backpack) an electronic device comprising a processor that is configured to generate messages indicating the receiver's location when receiving a low power wave transmission. In an alternative embodiment, the one or more receivers can determine its own location based upon characteristics of the received power waves as indicated by the received communication signal, and transmit it to the transmitter 102.

In one embodiment, the one or more antennas may be fixed upon movable elements and the distance between the one or more antennas in each of the one or more antenna arrays is dynamically adjusted depending on a location of portion within the transmission field where either a pocket of energy or null space has to be formed based on a comparison result of the calculated SAR value and the pre-defined SAR value for the given portion. The movable elements are any mechanical actuators that are controlled by the microprocessor of the transmitter. The microprocessor of the transmitter determines the location of the portion within the transmission field, and based on the location of the portion, the microprocessor controls the movement of the mechanical actuators on which the antennas are mounted.

The one or more antennas of each of the one or more antenna arrays may be configured to transmit the one or more power waves at a different time from each other because of the placement of the one or more antennas. In another embodiment, the one or more antennas of each of the one or more antenna arrays may be configured to transmit the one or more power waves at a different time from each other because of a presence of a timing circuit that is controlled by the microprocessor of the transmitter. The timing circuit can be used to select a different transmission time for each of the one or more antennas. In one example, the microprocessor may pre-configure the timing circuit with the timing of transmission of the one or more transmission waves from each of the one or more antennas. In another example, depending on a location of portion within the transmission field where either a pocket of energy or null space has to be formed based on a comparison result of the calculated SAR value and the pre-defined SAR value for the given portion, the transmitter may delay the transmission of few transmission waves from few antennas.

In one implementation, the transmitter may include an antenna circuit coupled to a switch, where each of the one or more antennas in the antenna array, are adjusted or otherwise selected depending on a location within the transmission field where power waves, a pocket of energy, or null space has to be formed or otherwise transmitted based on a comparison result of the calculated SAR value and the pre-defined SAR value for the given location. In one embodiment, the antenna array is configured such that the power wave direction can be steered in a first direction by switching on a first set of antennas of the one or more antennas, and the power wave direction of the antenna array can be steered in a second direction by switching on a second set of antennas of the one or more antennas. The second set of antennas can include one or more antennas from the first set of antennas, or the second set of antennas may not include any antennas from the first set. In one embodiment, the power wave direction of the antenna array can be steered in a plurality of directions by switching on a set of antennas from the one or more antennas for each of the plurality of directions. The selections of antennas in the first set of antennas and the second set of antennas are based upon the distances between the antennas in the first set of antennas and the second set of antennas. The distances are so chosen that the power waves emerging out of the first set, second set or any set of antennas generate effective transmission of a pocket of energy at the desired locations.

In another embodiment, the transmitter comprises at least two antenna arrays. In one example, the at least two antenna arrays comprises a first antenna array and a second antenna array. The microprocessor is configured to control the spacing between the first antenna array and the second antenna array. The distance between the first antenna array and the second antenna array is dynamically adjusted, depending on a location within the transmission field where either a pocket of energy or null space has to be formed based on a comparison result of the calculated SAR value and the pre-defined SAR value for the given portion. In an embodiment, the first antenna array and the second antenna array may be flat shaped and the offset distance between the at least two antenna arrays is 4 inches.

In another embodiment, the transmitter comprises at least two antenna arrays. In one example, the at least two antenna arrays comprises a first antenna array and a second antenna array. It should be noted that for the simplicity of explanation that the first antenna array and the second antenna array are being described; however, more than two antenna arrays may be included in the system without moving out from the scope of the disclosed embodiments. Each of the first antenna array and the second antenna array comprises one or more rows and one or more columns of antennas configured to transmit one or more power waves. In one example, the first antenna array and the second antenna array are both used for creation of the pocket of energy at the same time depending on a location within the transmission field where either a pocket of energy or null space has to be formed based on a comparison result of the calculated SAR value and the pre-defined SAR value for the given portion. In another example, the first antenna array and the second antenna array are both used for creation of the null space at the same time depending on a location within the transmission field where either a pocket of energy or null space has to be formed based on a comparison result of the calculated SAR value and the pre-defined SAR value for the given portion. In another example, the first antenna array and the second antenna array are both used for creation of the pocket of energy and the null space at the same time depending on the location within the transmission field where either a pocket of energy or null space has to be formed based on a comparison result of the calculated SAR value and the pre-defined SAR value for the given portion.

FIG. 1B shows components of a system 100 according to an exemplary embodiment. The exemplary system comprises a transmitter 102 configured to transmit one or more power waves 104 that are intended to maintain a consistent energy level, such that SAR levels do not exceed a SAR threshold, but there may be enough RF energy for a receiver 103 to capture and convert to electric power for an electronic device 108 coupled to the receiver 103. In the exemplary embodiment, a first location 105 comprises enough RF energy that the RF energy exceeds a SAR threshold; a second location 107 comprises RF energy that is uniform through the transmission field, and is compliant with the SAR threshold. The transmitter 102 may detect the non-compliant SAR value of the first location 105 through any number of techniques. For example, the transmitter 102 may continuously determine the SAR value of the power waves 104 that the transmitter 102 is generating to particular locations, at a given distance interval. In such examples, the transmitter 102 may determine that the first location 105, located at a given distance from the transmitter 102, and at a particular lateral interval, has power waves 104 being transmitted having particular characteristics that cause the RF energy at that location to exceed the SAR value threshold. Accordingly, the transmitter 102 may determine that the power waves 104 may be adjusted to maintain uniform energy levels across the transmission field.

FIG. 1C shows components of the system 100, according to the exemplary embodiment shown in FIG. 1B. In FIG. 1C, the transmitter 102 may have adjusted the power waves 104 generated and transmitted by the transmitter 102, to mitigate the RF energy exceeding the SAR threshold at the first location 105. As such, the RF energy of the power waves 104 remains uniform throughout the transmission field.

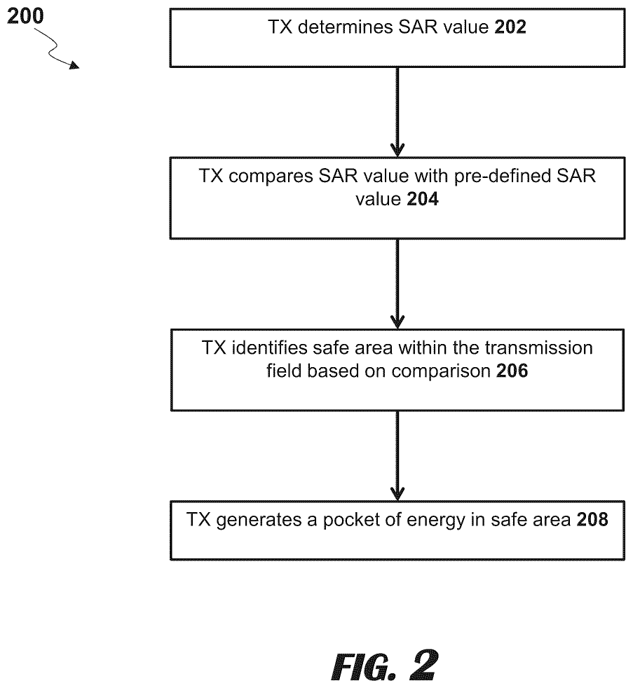

FIG. 2 illustrates a method to form a pocket of energy in a wireless power transmission system, according to an exemplary embodiment.

In a first step 202, a transmitter (TX) determines SAR values for each spatial location within a transmission field of the transmitter with respect to one or more power waves radiated from one or more antennas in the transmission field. For instance, in another embodiment, TX determines the SAR values obtained for each spatial location within the transmission field with respect to one or more power waves radiated from one or more antennas in the transmission field.

One having skill in the art would appreciate that SAR values may be predetermined or modeled according to a number of waveform parameters. The models and predetermined values are stored into memory or preprogrammed into a processor of the TX, and the waveform parameters are known to the TX as result of determining how to generate and transmit, or otherwise adjust, the power waves. For instance, the transmitter may determine a SAR value sample for a particular location using a model that uses the frequency, power level, antenna strength, and distance of one or more power waves entering the certain volume of space where the particular location is found. Using these known values and the model, the TX may determine how much power is generated by the power waves within the volume containing the location.

In a next step 204, the transmitter compares the SAR values for each spatial location within the transmission field with respect to one or more power waves radiated from one or more antennas in the transmission field with a pre-defined SAR value. In an embodiment, the pre-defined SAR value is 1.6 watts per kilogram (W/Kg). In another embodiment, the pre-defined SAR value can be any value established by the Federal Communications Commission (FCC).

In a next step 206, a microprocessor of the transmitter may execute one or more software modules in order to analyze the comparison between the SAR values for each spatial location within the transmission field with the pre-defined SAR value, and based on the analysis identify safe area within the transmission field. In one embodiment, the safe area is an area within the transmission field where the calculated SAR value is lesser than the pre-defined SAR threshold value.

The microprocessor will then determine the distance and size of the safe area from the transmitter, and based on the determined distance and the size of the safe area, the microprocessor may execute one or more software modules to select a power wave to be generated by the waveform generator, select the output frequency of the power wave, select a subset of antennas from a fixed physical shape of one or more antenna arrays that correspond to a desired spacing of antennas to form a pocket of energy at the safe area.

In one embodiment, the transmitter may adjust the power waves for the distance and the size of the safe area. For example, the transmitter may adjust the phase at which the transmitter's antenna transmits the power. When an optimal configuration for the antennas is identified, memory of the transmitter may store the configurations to keep the transmitter transmitting at that highest level. In another embodiment, the algorithms of the transmitter based on determined distance and the size of the safe area from the transmitter may determine when it is necessary to adjust the power waves and may also vary the configuration of the transmitter antennas. For example, the transmitter may determine the power received at the safe area is less than maximal, based on the determined distance and the size of the safe area. The transmitter may then adjust the phase of the power waves.

In the next step 208, the transmitter will transmit the one or more power waves to converge constructively at the safe area within the transmission field to generate the pocket of energy at the safe area.

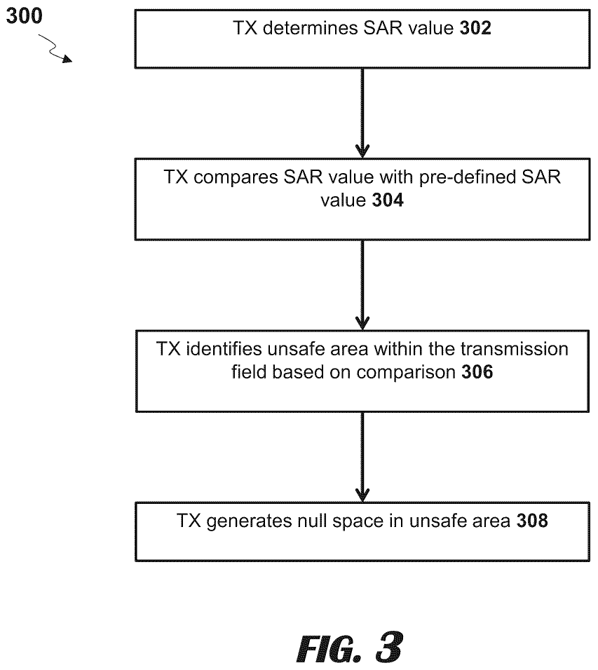

FIG. 3 illustrates a method for forming a null space in a wireless power transmission system, according to an exemplary embodiment.

In a first step 302, a transmitter (TX) calculates SAR values for each spatial location within a transmission field of the transmitter. In another embodiment, TX receives the SAR values obtained for each spatial location within the transmission field.

In a next step 304, the transmitter compares the SAR values for each spatial location within the transmission field with a pre-defined SAR value. In an embodiment, the pre-defined SAR value is 1.6 watts per kilogram (W/Kg). In another embodiment, the pre-defined SAR value can be any value established by the Federal Communications Commission (FCC).

In a next step 306, a microprocessor of the transmitter may execute one or more software modules in order to analyze the comparison between the SAR values for each spatial location within the transmission field with the pre-defined SAR value, and based on the analysis identify unsafe area within the transmission field. In one embodiment, the unsafe area is an area within the transmission field where the calculated SAR value for each spatial location within the transmission field is greater than to the pre-defined SAR value.

The microprocessor will then determine the distance and size of the unsafe area from the transmitter, and based on the determined distance and the size of the unsafe area from the transmitter, the microprocessor may execute one or more software modules to select a power wave to be generated by the waveform generator, select the output frequency of the power wave, select a subset of antennas from a fixed physical shape of one or more antenna arrays that correspond to a desired spacing of antennas to form null space at the unsafe area.

In one embodiment, the distance and the size of the unsafe area from the transmitter, as calculated according to transmitter algorithms, may vary production and transmission of power waves by the transmitter's antennas to form null space at the unsafe area. For example, the transmitter may adjust the phase at which the transmitter's antenna transmits the power. When an optimal configuration for the antennas is identified, memory of the transmitter may store the configurations to keep the transmitter transmitting at that highest level. In another embodiment, the algorithms of the transmitter based on determined distance and the size of the unsafe area from the transmitter may determine when it is necessary to adjust the power waves and may also vary the configuration of the transmitter antennas.

In the next step 308, the transmitter will transmit the one or more power waves to converge destructively at the unsafe area within the transmission field to form the null space. In an embodiment, the unsafe area may receive multiple power transmission signals from the transmitter. Each of the multiple power transmission signals comprises the power waves from multiple antennas of the transmitter. The composite of these power transmission signals may be essentially zero, because the power waves add together destructively to create the null space.

In another embodiment, at least two power waves may be generated by a waveform generator of the transmitter. The at least two power waves generated may have different frequencies. The change in phase of the frequency of one of the at least two power waves may result in formation of a unified power wave. The uniform power wave may be such that it will generate the null space at the unsafe area in the transmission field, along with generation of the pocket of energy in areas other than the unsafe area in the transmission field.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

What is claimed is:

1. A method of monitoring specific absorption rate (SAR) values to determine when to wirelessly transmit power to a receiver, the method comprising:
receiving, at a wireless-power transmission device, an indication from a receiver responsive to wirelessly delivered RF power, the receiver being present at a location within a transmission field of the wireless-power transmission device;
in response to receiving the indication, determining transmission characteristics to use for transmitting radio frequency power transmission signals to the receiver;
determining, using stored SAR value determination criteria and one or more of the transmission characteristics, a predicted SAR value that would be present at the location after the radio frequency power transmission signals with the transmission characteristics would be transmitted to the location of the receiver; and
in accordance with a determination that the predicted SAR value would be less than a predefined SAR value, causing the wireless-power transmission device to transmit the radio frequency power transmission signals to the receiver.
